(19) United States
(12) Patent Application Publication
(10) Pub. No.: US 2006/0256993 A1
(43) Pub. Date: Nov. 16, 2006

(54) Plugging structure for plugging earphones

(75) Inventor: Yao-Sheng Kao, Hsin-Tien City (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/129,374

(22) Filed: May 16, 2005

(51) Int. Cl. H04R 25/00

(52) U.S. Cl. 381/380

(57) ABSTRACT

A plugging structure for plugging earphones includes an extending mechanism, an operation member and an outer guarding cover. The extending mechanism has elastic arms extending outwards radially in normal conditions. The outer guarding cover encases the elastic arms. The operation member has a coupling ring coupled on the elastic arms and a pushbutton exposed outside the earphone. The pushbutton may be depressed to control the coupling ring to retract the elastic arms or release the elastic arms thereby to adjust the size of the earphone after being inserted in user's ear canal. Thus the uncomfortable feeling occurred to the hanging earphone may be prevented and a snug wearing in user's ear canal can be achieved.

### FIELD OF THE INVENTION

The present invention relates to a plugging earphone and particularly to a plugging structure for plugging earphones.

### BACKGROUND OF THE INVENTION

Earphone has been known in the art for a long time. With the portable multimedia devices now become very popular, the earphone also is widely used. These days the earphone can provide high quality audio output. A wide variety of earphone designs also are available on the market. With rapid developments of Bluetooth wireless transmission technology, Bluetooth earphone also gradually becomes an important accessory in mobile communication devices. Nokia Corporation predicts that the Bluetooth earphone is entering a rapid growth period now. More Bluetooth peripheral devices will be introduced. Handset producer Nokia Corporation already announced a series of Bluetooth earphones and vehicle handfree accessories. Another earphone producer Jabra also has announced a Bluetooth earphone with advanced functions. Hence people on the move now have many selections.

The conventional earphone mainly aims to output sound. It mainly includes a plug type and a headset type. The plug earphone has the speaker shrunk to a size insertable in a human ear (such as Taiwan, R.O.C. patent No. M253176 entitled “Improved guarding cover for plugging earphones”). At present, the wireless Bluetooth earphone mating the mobile phone includes a mike in addition to the basic speaker. In order to make user's wearing of the Bluetooth earphone more comfortable, the size and weight of the Bluetooth earphone have to be minimized.

Wearing of the Bluetooth earphone mostly adopts plugging and hanging. For instance, Taiwan, R.O.C. patent No. M258535 entitled “Hanging type earphone” and No. M260069 entitled “Bluetooth wireless earphone” are hanging earphones. These earphones have a movable hanging hook to be hung on user's external ear (concha). However, these types of earphones tend to create uncomfortable feeling or even pain for users when used for a long period of time. On the other hand, the plugging Bluetooth earphone has a shrunk size and can be inserted in user's ear canal for bracing. But the speaker of the plugging earphone often has a fixed dimension which is often not matching the size of user's ear canal. To wear a large plugging earphone forcefully, user's ear is painful. On the contrary, if the dimension of the earphone is too small, it cannot be worn snugly and tends to drop away.

### SUMMARY OF THE INVENTION

Therefore the primary object of the present invention is to provide a plugging structure for plugging earphones that can be adjusted to match the size of user's ear canal after being worn to avoid the uncomfortable feeling of the hanging earphone and to be worn snugly in user's ear canal.

According to an embodiment of the invention, the plugging structure for plugging earphones includes an extending mechanism, a movable operation member and an outer guarding cover encasing elastic arms. The elastic arms are located in the extending mechanism that are extended outwards radially in normal conditions. The operation member has a coupling ring coupled on the elastic arms. Users can move the operation member to control the coupling ring to retract the elastic arms towards the center or release the elastic arms thereby to adjust the size after having been inserted into the ear canal.

The elastic arms may include more than one set and are made from metal wires or plastics to be extended outwards radially. Another embodiment is to form the elastic arms in a conical fashion and made from plastics or rubber.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the present invention.

FIG. 2A is a sectional view of an embodiment of the present invention.

FIGS. 2B and 2C are schematic views according to FIG. 2A in operating conditions.

### DETAILED DESCRIPTION OF THE PREFERRED EMBODIMENTS

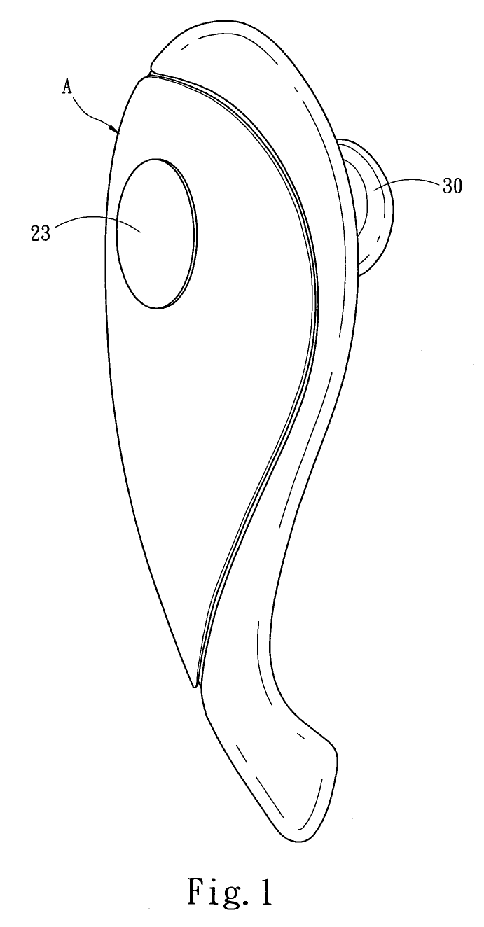

Please refer to FIG. 1 for an embodiment of the plugging structure for plugging earphones of the invention. It is installed on an earphone body A, and includes an extending mechanism, an operation member 20 and an outer guarding cover 30.

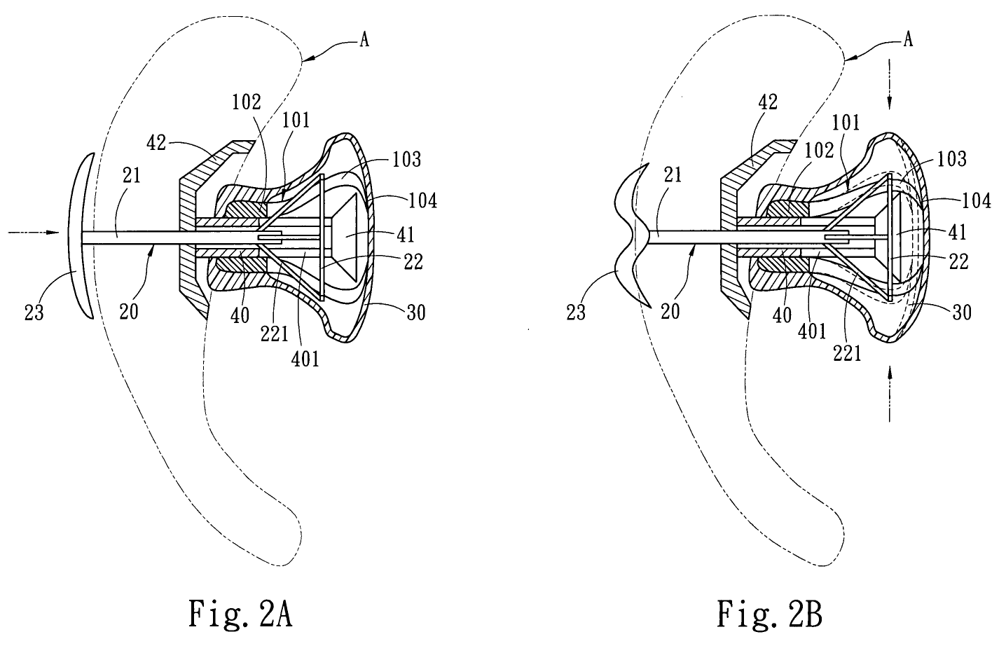

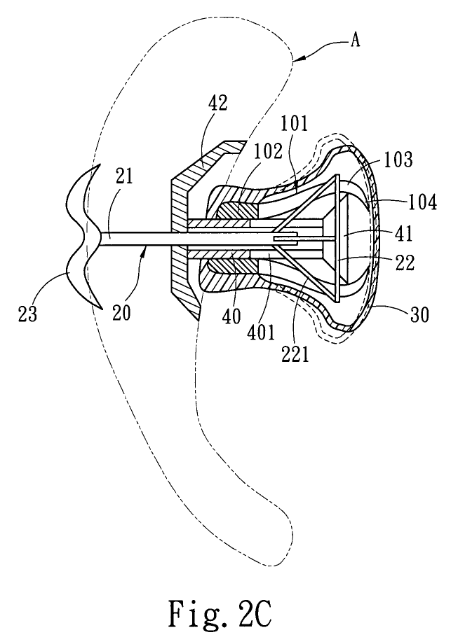

Referring to FIG. 2A, according to an embodiment, the extending mechanism has elastic arms 101 which are extended outwards radially in normal conditions. The elastic arms 101 are preferably made of metal wires. Each of the elastic arms 101 has a head end 102 fixedly coupled on a speaker bracket 40 and a tail end 103 extended outwards radially. As shown in the drawings, the tail end 103 is preferably formed in a curved shape and has a distal end 104 close to the center. Hence the entire elastic arms 101 are formed like a mushroom. In the normal conditions, the distal end 104 of the elastic arms 101 is spaced from each other for a selected distance to form a greater outer diameter. As the tail end 103 is formed in a curved shape, it can be inserted in the ear canal without problem.

The elastic arms 101 may also be made from plastics. Another embodiment is to form the elastic arms 101 in a conical and elastic fashion and to be made from plastics or rubber.

The speaker bracket 40 is hollow, and has a front end coupled with a speaker 41 and another end fastened to a bracket 42 of the earphone body A. The speaker 41 is surrounded by the tail end 103 of the elastic arms 101. The operation member 20 has an axle 21 movably running through the speaker bracket 40 in the axial direction. The axle 21 has a coupling ring 22 on one end to couple with the elastic arms 101. The coupling ring 22 is coupled on the axle 21 through a plurality of bracing ribs 221. The bracing ribs 221 are extended axially from the speaker bracket 40 and spaced by crevices 401 to couple with the coupling ring 22. The axle 21 has other end to couple with a pushbutton 23 which is exposed outside the earphone body A. The outer guarding cover 30 encases the entire elastic arms 101 and the coupling ring 22, and is made from rubber or silicon rubber that is pliable to prevent uncomfortable feeling when worn by users. As the elastic arms 101 are elastic and deformable, and can be controlled through the coupling ring 22 of the operation member 20, it can be retracted when the distal end 104 of the elastic arms 101 are retracted to the center or released to adjust the size after being inserted in the ear canal. Hence the uncomfortable feeling that occurs to the hanging earphone can be prevented, and the size may be adjusted to match the ear canal.

Referring to FIGS. 2B and 2C, for removing the plugging earphone of the invention from user's ear, depress the pushbutton 23; the axle 21 is pushed in the direction of the tail end 103 of the elastic arms 101; the distal end 104 of the elastic arms 101 is retracted towards the center, and the outer diameter of the elastic arms 101 becomes smaller; then the plugging earphone can be removed easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A plugging structure for plugging earphones to be installed on an earphone body, comprising:
an extending mechanism with elastic arms extended outwards radially in normal conditions;
an operation member having a movable axle which has one end coupled with a coupling ring to couple with the elastic arms and another end coupled with a pushbutton exposed outside the earphone body, the axle being movable by the pushbutton to control the coupling ring thereby to retract the elastic arms towards the center or release the elastic arms; and
an outer guarding cover encasing the elastic arms and the coupling ring.

2. The plugging structure for plugging earphones of claim 1, wherein the elastic arms are elastic and made of metal wires or plastics.

3. The plugging structure for plugging earphones of claim 2, wherein each of the elastic arms has a head end close to each other and being anchored, and a tail end extended radially outwards.

4. The plugging structure for plugging earphones of claim 3, wherein the tail end of the elastic arms is formed in a curved shape and close toward the center, and spaced from each other for a selected distance in the normal conditions.

5. The plugging structure for plugging earphones of claim 1, wherein the elastic arms are conical and elastic.

6. The plugging structure for plugging earphones of claim 5, wherein the elastic arms are made from plastics or silicon rubber.

7. The plugging structure for plugging earphones of claim 1, wherein the outer guarding cover is made from an elastic and pliable material which includes rubber or silicon rubber.
